(19) United States
(12) Patent Application Publication
(10) Pub. No.: US 2009/0289119 A1
(43) Pub. Date: Nov. 26, 2009

(54) CARD READER

(75) Inventors: Shih-Hung Liao, Hsichih City (TW); Chen-An Wu, Hsichih City (TW); Yu-Chien Chueh, Hsichih City (TW); Chih-Chien Lin, Hsichih City (TW); Wu-Hsiung Chen, Hsichih City (TW)

Correspondence Address: BACON & THOMAS, PLLC, 625 SLATERS LANE, FOURTH FLOOR, ALEXANDRIA, VA, 22314-1176, US

(73) Assignee: CHANT SINCERE CO., LTD., Hsichih City (TW)

(21) Appl. No.: 12/345,687

(22) Filed: Dec. 30, 2008

(30) Foreign Application Priority Data
May 23, 2008 (TW) 097119244

(51) Int. Cl. G06K 7/06

(52) U.S. Cl. 235/441

(57) ABSTRACT

A card reader includes a USB standard casing, a holder block fastened to the USB standard casing and defining therein an insertion hole for the insertion of an electronic card, a circuit board mounted in the USB standard casing and having a first contact set configured subject to the USB specification and a second contact set, and an electric connector electrically connected to the second contact set and kept in proximity to the insertion hole for the contact of an electronic card electrically.

### This application claims the priority benefit of Taiwan patent application number 097119244 filed on May 23, 2008.

### BACKGROUND OF THE INVENTION

1. Field of the Invention

The present invention relates to card readers and more particularly, to such a card reader that has a USB standard casing at the front side for insertion into a USB port of an external electronic device, a holder block at the rear side for the insertion of an electronic card, and an electric module mounted in the USB standard casing to constitute with the USB standard casing a USB connector and to electrically connect an electronic card that is inserted into the holder block to the linked external electronic device for two-way data transmission.

2. Description of the Related Art

Following the step of the development of high technology, various digitalized electric and electronic products are created. These high-tech electronic products, such as digital camera, digital video camera, cellular telephone, MP3 player, MP4 player, digital recorder and etc. commonly provide multiple functions and use an electronic (memory) card for storing static/dynamic audio and/or video data. For convenient use and easy carrying, electronic products are made having light, thin, short and small characteristics. In consequence, electronic component parts, electronic connectors and electronic cards must be small-sized to fit the requirements.

Currently, many electronic (memory) cards are commercially available, including MMC (MultiMediaCard), CF (Compact Flash Card), SMC (Smart Media Card), MS (Memory Stick), SD (Secure Digital Memory Card), SM (SmartMedia), and other mini and micro electronic (memory) cards, such as Mini SD, MS Duo, Trans Flash (Micro SD), and etc.

Further, a card reader is an interface between a memory card and a computer. Through a USB port, a computer allows data transmission with a card reader. By means of hot swap, a computer can read the storage data of a card reader rapidly. However, regular commercial card readers have a big size, not convenient for carrying. Therefore, a regular card reader cannot be directly connected to a USB port of a computer. For connecting a card reader to a USB port of a computer, a USB cable must be used.

Further, a computer usually has multiple USB ports arranged close to one another subject to the stacked electric connectors inside the housing of the computer. When a mobile electronic device (memory stick, card reader, or the like) is inserted into one USB port of a computer, the inserted mobile electronic device may hinder insertion of another mobile electronic device into an adjacent USB port of the computer.

Therefore, it is desirable to provide a compact card reader that eliminates the aforesaid drawbacks.

### SUMMARY OF THE INVENTION

The present invention has been accomplished under the circumstances in view. It is therefore one object of the present invention to provide a card reader, which is small-sized and configured for direct insertion into a USB port of an electronic apparatus without hindering insertion of a mobile electronic device into a neighbor USB port of the electronic apparatus.

To achieve this and other objects of the present invention, the card reader comprises a housing and an electric module mounted in the housing. The housing comprises a USB standard casing and a holder block fastened to the rear side of the USB standard casing. The USB standard casing defines therein an accommodation chamber. The holder block defines an insertion hole for the insertion of an electronic card. The insertion hole is disposed in communication with the accommodation chamber perpendicularly. The electric module comprises a circuit board mounted in the accommodation chamber of the USB standard casing. The circuit board comprises a first contact set configured subject to the USB specification, and a second contact set disposed remote from the first contact set. The electric module further comprises an electric connector perpendicularly mounted on the circuit board and electrically connected to the second contact set and kept in proximity to the insertion hole of the holder block for the contact of an electronic card electrically.

Further, an expansion device is provided at the bottom side of the circuit board inside the USB standard casing for receiving an electronic card. The expansion device comprises an electrically insulative rack fastened to the bottom wall of the circuit board and defining with the bottom wall of the USB standard casing an insertion space for the insertion of an electronic card, and a plurality of conducting terminals mounted in the electrically insulative rack for the contact of an electronic card electrically.

### BRIEF DESCRIPTION OF THE DRAWINGS

FIG. 1 is an elevational view of a card reader in accordance with a first embodiment of the present invention.

FIG. 2 is an exploded view of the card reader in accordance with the first embodiment of the present invention.

FIG. 3 is another exploded view of the card reader in accordance with the first embodiment of the present invention.

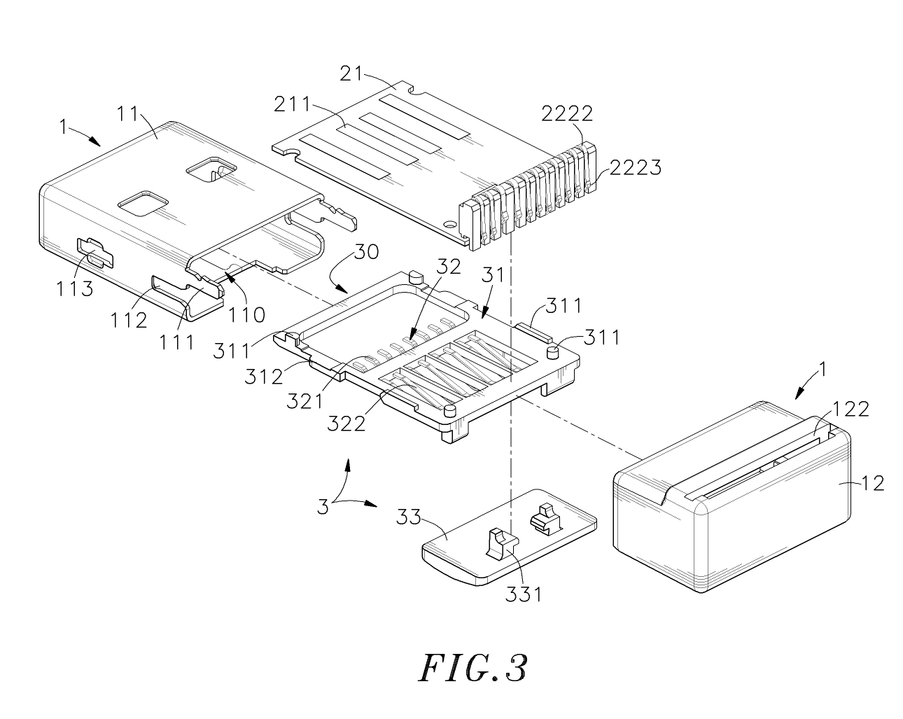

FIG. 4 is an exploded view of the electric module of the card reader in accordance with the first embodiment of the present invention.

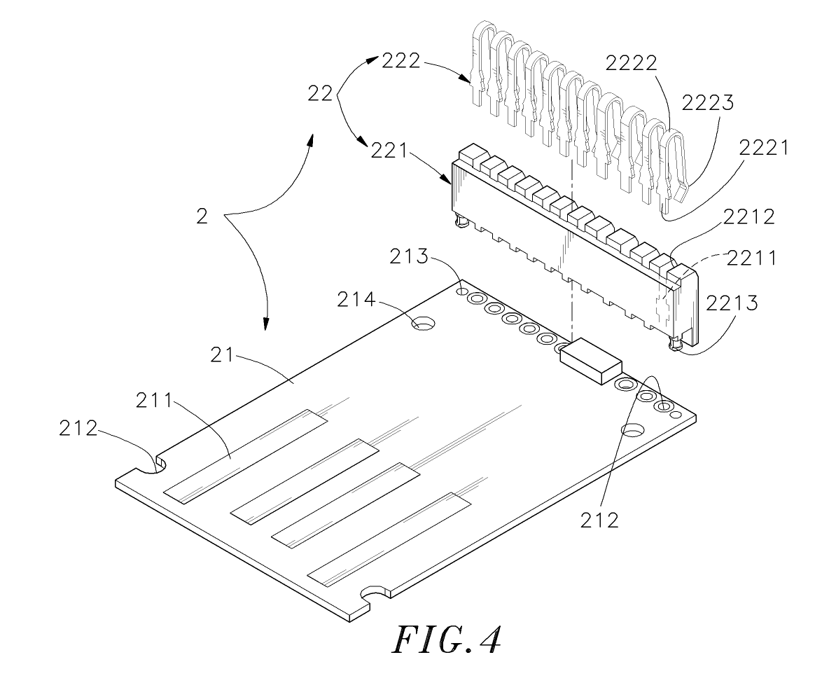

FIG. 5 is a perspective view of the first embodiment of the present invention before insertion of electronic cards into the insertion space in the USB standard casing and the insertion hole of the holder block.

FIG. 6 is a sectional view of the first embodiment of the present invention after insertion of the electronic cards into the insertion space in the USB standard casing and the insertion hole of the holder block.

FIG. 7 is a sectional view of a card reader in accordance with a second embodiment of the present invention after insertion of electronic cards into the insertion space in the USB standard casing the insertion hole of the holder block.

FIG. 8 is a sectional view showing one card reader of the first embodiment of the present invention and one card reader of the second embodiment of the present invention respectively inserted into two adjacent USB ports of an external electronic device.

FIG. 9 is an elevational view showing one card reader of the first embodiment of the present invention and one card reader of the second embodiment of the present invention respectively inserted into two adjacent USB ports of an external electronic device.

### DETAILED DESCRIPTION OF THE PREFERRED EMBODIMENT

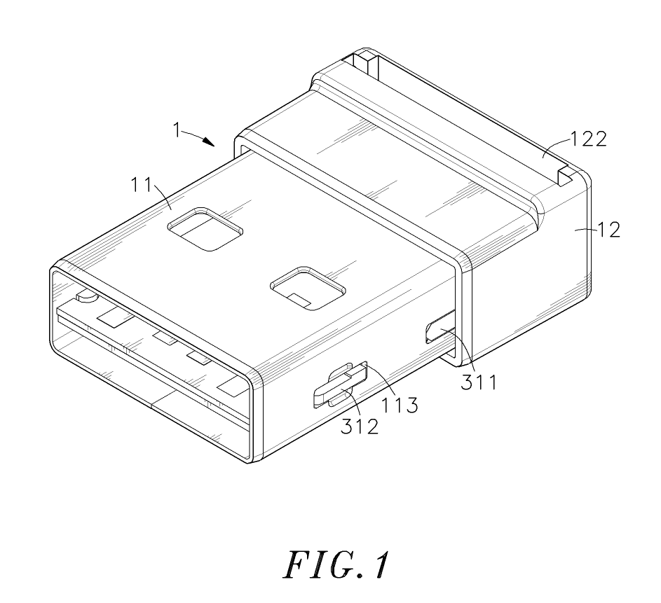

Referring to FIGS. 1˜4, a card reader in accordance with a first embodiment of the present invention is shown. The card reader is comprised of a housing 1, an electric module 2 and an expansion device 3.

The housing 1 comprises a USB standard casing 11, and a holder block 12 fixedly connected to the rear side of the USB standard casing 11. The USB standard casing 11 defines therein an accommodation chamber 110 that accommodates the electric module 2. The holder block 12 has a front opening 121 kept in communication with the accommodation chamber 110, and an insertion hole 122 perpendicularly disposed in communication with the front opening 121.

The electric module 2 comprises a circuit board 21 and an electric connector 22. The circuit board 21 is mounted in the accommodation chamber 110 inside the USB standard casing 11, comprising a first contact set 211 configured subject to the USB specification, and a second contact set 212 disposed remote from the first contact set 211. The electric connector 22 is perpendicularly fastened to the circuit board 21 and electrically connected to the second contact set 212. The electric connector 22 comprises an electrically insulative terminal holder 221, which has a plurality of terminals slots 2211, a plurality of locating grooves 2212 respectively disposed at one lateral side relative to the terminal slots 2211 and a plurality of bottom mounting rods 2213, and a plurality of conducting terminals 222 respectively mounted in the terminal slots 2211 of the electrically insulative terminal holder 221. Each conducting terminal 222 has a solder end 2221 vertically inserted into one terminal slot 2211 and forced into friction engagement with the peripheral wall of the associating terminal slot 2211, a springy contact end 2223 suspending in one associating locating groove 2212 within the insertion path of the insertion hole 122 of the holder block 12, and an arched connection portion 2222 connected between the solder end 2221 and the springy contact end 2223.

The expansion device 3 is fastened to the bottom side of the electric module 2, comprising an electrically insulative rack 31 and a set of conducting terminals 32 installed in the electrically insulative rack 31. Each conducting terminal 32 has a solder end 321 electrically bonded to one respective contact (not shown) at the bottom side of the circuit board 21, and a contact end 322 obliquely extending to an insertion space 30 defined within the accommodation chamber 110 between the electrically insulative rack 31 and the bottom wall of the USB standard casing 11. The electrically insulative rack 31 has a plurality of male locating portions (locating rods and strips) 311 respectively fastened to locating holes 214 on the circuit board 21 and clamped on the periphery of the circuit board 21.

During installation, the solder ends 2221 of the conducting terminals 222 of the electric connector 22 are respectively inserted into the terminal slots 2211 of the electrically insulative terminal holder 221 to have the springy contact ends 2223 of the conducting terminals 222 be suspending in the respective locating grooves 2212, and then the bottom mounting rods 2213 of the electrically insulative terminal holder 221 of the electric connector 22 are respectively fastened to respective mounting holes 213 on the circuit board 21 to tightly secure the electric connector 22 to the circuit board 21 and to have the solder ends 2221 of the conducting terminals 222 of the electric connector 22 be respectively connected to the second contact set 212 of the circuit board 21. Thereafter, the male locating portions (locating rods and strips) 311 of the electrically insulative rack 31 of the expansion device 3 are respectively fastened to the locating holes 214 on the circuit board 21 and clamped on the periphery of the circuit board 21, and then the electric module 2 and the expansion device 3 are inserted into the accommodation chamber 110 inside the USB standard casing 11 to have two male locating portions (locating strips) 311 and two transversely extending springy retaining strips 312 of the electrically insulative rack 31 be respectively coupled to respective retaining notches 112 and retaining hole 113 on two opposite sidewalls of the USB standard casing 11. At this time, the circuit board 21 and the electrically insulative rack 31 divide the accommodation chamber 110 of the USB standard casing 11 into two vertically spaced insertion spaces 30. Thereafter, insert two rear friction arms 111 of the USB standard casing 11 into two positioning grooves 123 in the front opening 121 of the holder block 12 of the housing 1 to force the two male locating portions (locating strips) 311, which are coupled to the retaining notches 112 of the USB standard casing 11, be coupled to respective coupling grooves 124 in the holder block 12 of the housing 1. At this time, the holder block 12 is tightly secured to the rear side of the USB standard casing 11, keeping the first contact set 211 of the circuit board 21 in the front side inside the accommodation chamber 110 and the electric connector 22 in proximity to the insertion path of the insertion hole 122 of the holder block 12. Thereafter, couple two push blocks 331 of a card ejector 33 to respective bottom sliding holes 125 on the bottom wall of the holder block 12 to have the push blocks 331 be positioned in the holder block 12 in the rear side of the insertion space 30 below the electrically insulative rack 31. Thus, the installation of the card reader is done.

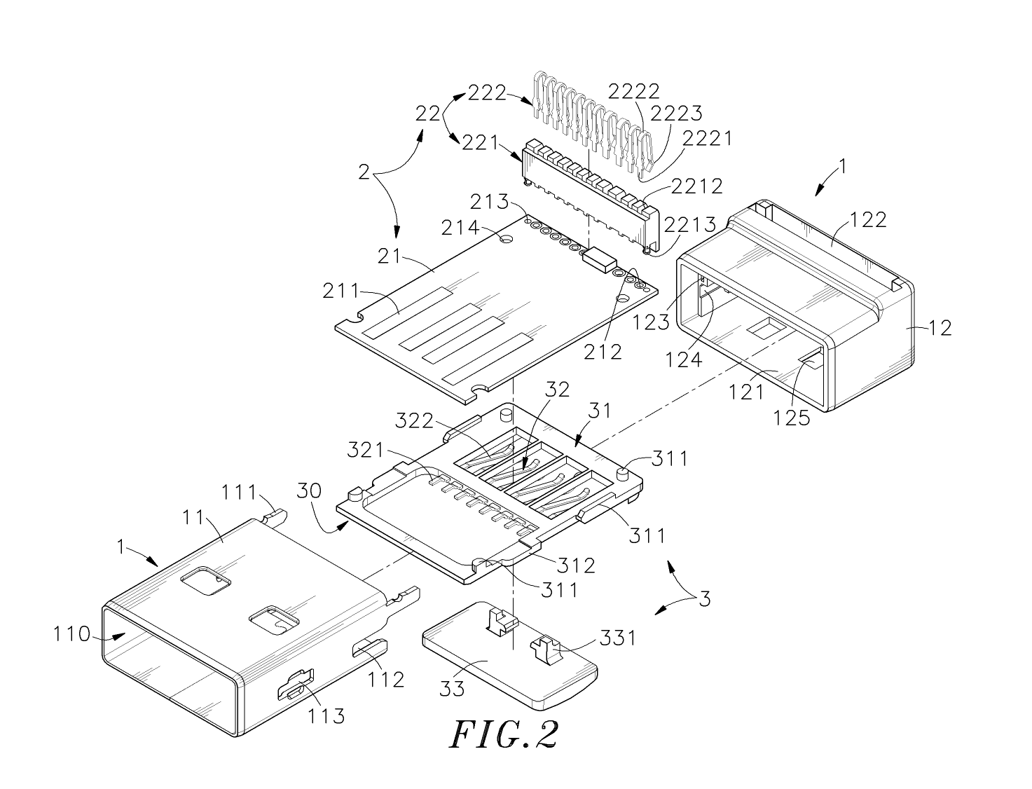

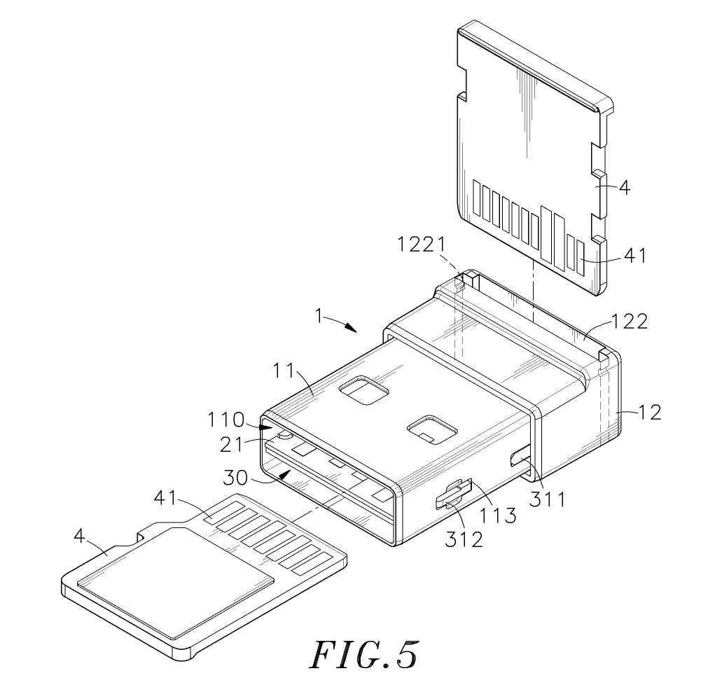

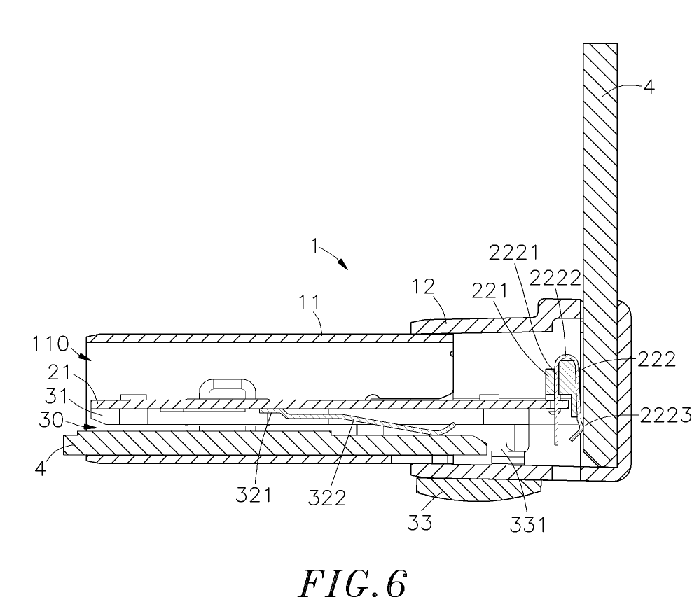

Referring to FIGS. 5 and 6 and FIG. 2 again, the card reader allows insertion of two electronic cards 4. One first electronic card 4 is vertically inserted into the insertion hole 122 of the holder block 12 of the housing 1 to force its contacts 41 into contact with the springy contact ends 2223 of the conducting terminals 222 of the electric connector 22. At this time, the springy contact ends 2223 of the conducting terminals 222 are biased inwards toward the inside of the associating locating grooves 2212 on the electrically insulative terminal holder 221 and kept in positive contact with the respective contacts 41. Further, the holder block 12 has two retaining protrusions 1221 disposed at two opposite lateral sides in the insertion hole 122 for securing the inserted electronic card 4 in place, keeping the inserted electric card 4 in positive contact with the conducting terminals 222. Further, one second electronic card 4 can be horizontally inserted into the insertion space 30 within the accommodation chamber 110 of the USB standard casing 11 below the electrically insulative rack 31 to have its contacts 41 be forced into contact with the contact ends 322 of the conducting terminals 32 of the expansion device 3. Thus, the USB standard casing 11 receives one electronic card 4 and the holder block 12 receives another electronic card 4, i.e., the card reader has two electronic cards 4 inserted therein.

When wishing to remove the electronic card 4 from the holder block 12, apply an upward pull force to the electronic card 4 to disengage the electronic card 4 from the retaining protrusions 1221 and to move away the contacts 41 of the electronic card 4 from the contact ends 2223 of the conducting terminals 222 of the electric connector 22 in the insertion hole 122, and thus the electronic card 4 is removed from the top insertion hole 122 of the holder block 12. Further, when wishing to remove the electronic card 4 from the insertion space 30, push the card ejector 33 in the card ejection direction to move the push blocks 331 along the respective bottom sliding holes 125 of the holder block 12, thereby moving the electronic card 4 out of the insertion space 30. Thus, the user can then take the electronic card 4 out of the USB standard casing 11.

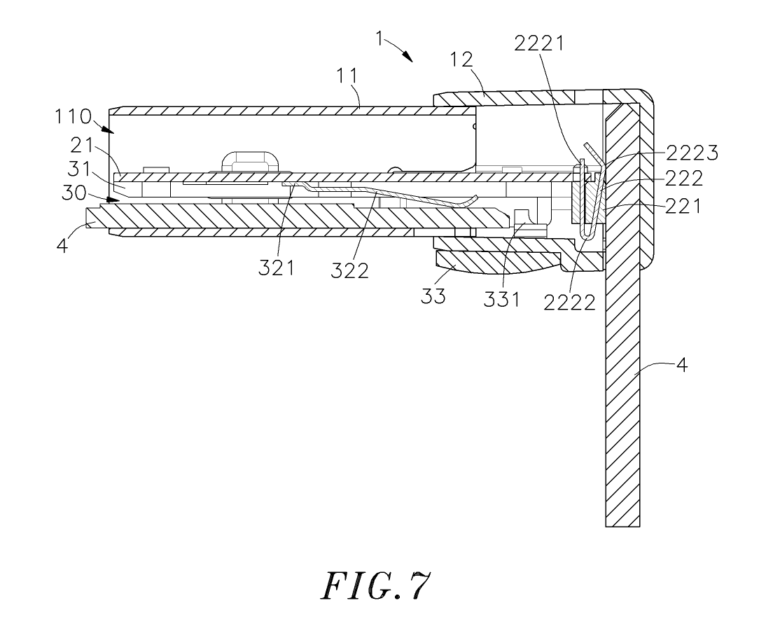

In the aforesaid embodiment, the electric connector 22 is mounted on the top wall of the circuit board 21 and kept in proximity to the insertion hole 122 of the holder block 12 of the housing 1 for the contact of one electronic card 4 to be inserted into the insertion hole 122. FIG. 7 shows a card reader in accordance with a second embodiment of the present invention. This second embodiment is substantially similar to the aforesaid first embodiment with the exception that the electric connector 22 according to this second embodiment is mounted on the bottom wall of the circuit board 21, and the holder block 12 according to this second embodiment has an insertion hole 122 formed in its bottom side for the insertion of one electronic card 4 into contact with the electric connector 22.

Referring to FIGS. 8 and 9 and FIG. 2 again, by means of the USB standard casing 11, the card reader can be inserted into a USB port 51 of an external electronic device 5 to force the first contact set 211 of the circuit board 21 into contact with an USB connector 52 in the USB port 51, allowing transmission of data from the electronic card 4 in the housing 1 to the external electronic device 5 or transmission of data from the external electronic device 5 to the electronic card 4 in the housing 1.

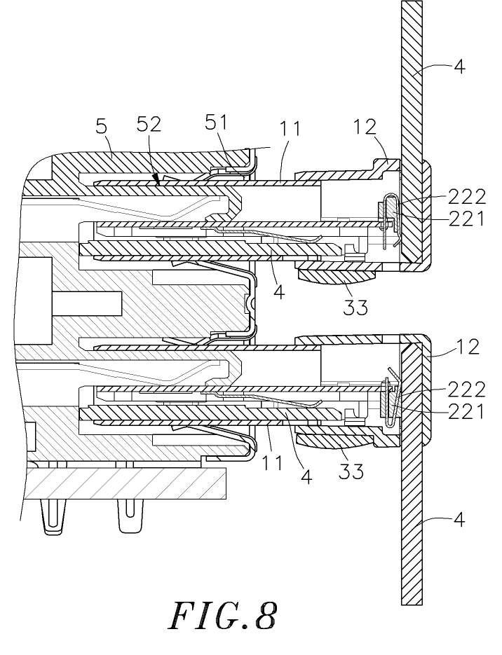

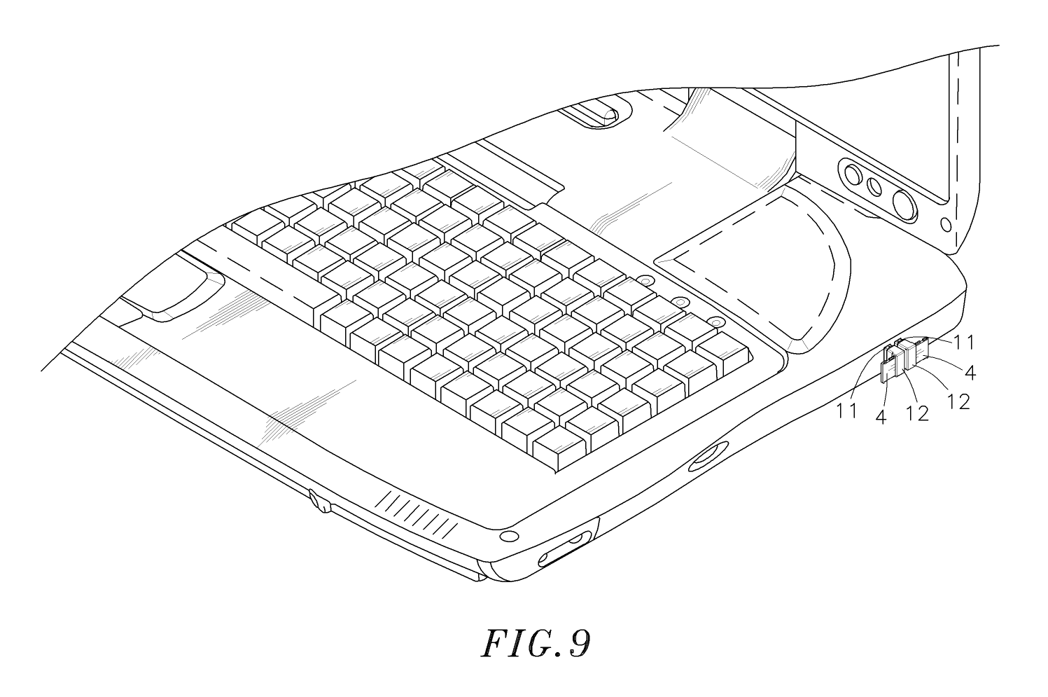

Further, one card reader constructed according to the first embodiment of the present invention and one card reader constructed according to the second embodiment of the present invention can be respectively inserted into two adjacent USB ports 51 of the external electronic devices 5, as shown in FIGS. 8 and 9. At this time, the electronic cards 4 that are respectively inserted into the holder blocks 12 of the two card readers extend in reversed direction without causing any interference.

Further, during the assembly process of the card reader, the holder block 12 can be fastened to the rear side of the USB standard casing 11 in one of two reversed directions subject to the installation position of the electric connector 22 on the circuit board 21, i.e., the holder block 12 of the card reader according to the first embodiment of the present invention is identical as that of the card reader according to the second embodiment. This design simplifies the fabrication of the holder block 12. Further, the electric connector 22 can be mounted on the top wall or bottom wall of the circuit board 21 to match the positioning of the holder block 12 for top loading or bottom loading of an electronic card 4.

Further, the aforesaid electronic cards 4 can be CF (Compact Flash), SD (Secure Digital), Mini SD (Mini Secure Digital), SM (SmartMedia) or other memory cards that allow two-way data transmission (reading and storing). Further, the aforesaid external electronic device 5 can be a desktop computer, Notebook computer, PDA or multipurpose office machine.

Further, the USB standard casing 11 of the housing 1 can be injection-molded from plastics and incorporated with the first contact set 211 of the circuit board 21 to constitute a USB connector (USB plug or USB socket). The holder block 12 is fastened to the rear side of the USB standard casing 11, defining a vertical insertion hole 122 for the insertion of the electronic card 4. The card reader of the present invention shows light, thin, short and small characteristics, convenient for carrying and requiring less installation space.

In conclusion, the present invention provides a card reader, which has the following features and advantages:

1. The housing 1 of the card reader comprises a USB standard casing 11 and accommodates an electric module 2 on the inside. The circuit board 21 of the electronic module 2 comprises a first contact set 211 fitting the USB standard casing 11. The housing 1 of the card reader further comprises a holder block 12 fastened to the rear side of the USB standard casing 11. The holder block 12 defines an insertion hole 122 for the insertion of an electronic card 4, which is kept in contact with the electric connector 22 at the rear side of the circuit board 21. By means of the USB standard casing 11, the small-sized card reader can be inserted into an USB port of an external electronic device 5 for two-way data transmission between the external electronic device 5 and the electronic card 4 that is inserted into the insertion hole 122 of the holder block 12.

2. An expansion device 3 is mounted in the bottom side of the circuit board 21 inside the USB standard casing 11, so that an insertion space 30 is defined between the electrically insulative rack 31 of the expansion device 3 and the bottom wall of the USB standard casing 11 for the insertion of an electronic card 4. When an electronic card 4 is inserted into the insertion space 30, the electric contacts 41 of the electronic card 4 are kept in contact with the conducting terminals 32 of the expansion device 3. Therefore, the small-sized card reader allows installation of two electronic cards 4.

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

1. A card reader, comprising:
a housing, said housing comprising a USB standard casing and a holder block fastened to a rear side of said USB standard casing; said USB standard casing defining therein an accommodation chamber, said holder block defining an insertion hole for the insertion of an electronic card, said insertion hole being disposed in communication with said accommodation chamber perpendicularly; and
an electric module mounted in said housing, said electric module comprising a circuit board mounted in said accommodation chamber of said USB standard casing, said circuit board comprising a first contact set configured subject to the USB specification and a second contact set disposed remote from said first contact set, and an electric connector perpendicularly mounted on said circuit board and electrically connected to said second contact set and kept in proximity to said insertion hole for the contact of an electronic card electrically.

2. The card reader as claimed in claim 1, wherein said insertion hole of said holder block is formed in a top side of said holder block for the loading of an electronic card into said holder block from the top side.

3. The card reader as claimed in claim 1, wherein said insertion hole of said holder block is formed in a bottom side of said holder block for the loading of an electronic card into said holder block from the bottom side.

4. The card reader as claimed in claim 1, wherein said holder block comprises two retaining protrusions disposed in said insertion hole at two opposite lateral sides for holding the inserted electronic card in contact with said electric connector electrically.

5. The card reader as claimed in claim 1, wherein said holder block comprises a front opening disposed in communication with said accommodation chamber of said USB standard casing, and two positioning grooves bilaterally disposed in said front opening; said USB standard casing comprises two rear friction arms respectively fastened to said positioning grooves of said holder block.

6. The card reader as claimed in claim 1, wherein said electric connector of said electric module is mounted on a top wall of said circuit board.

7. The card reader as claimed in claim 1, wherein said electric connector of said electric module is mounted on a bottom wall of said circuit board.

8. The card reader as claimed in claim 1, wherein said electric connector comprises an electrically insulative terminal holder and a plurality of conducting terminals mounted in said electrically insulative terminal holder, said electrically insulative terminal holder comprising a plurality of terminal slots and a plurality of locating grooves respectively disposed at one side relative to said terminal slots, each said conducting terminal of said electric connector comprising a solder end mounted in one said terminal slot and bonded to said second contact set of said circuit board, a springy contact end suspending in one said locating groove of said electrically insulative terminal holder, and an arched connection portion connected between said solder end and said springy contact end of said respective conducting terminal of said electric connector.

9. The card reader as claimed in claim 1, wherein said circuit board comprises a plurality of mounting holes; said electrically insulative terminal holder comprises a plurality of bottom mounting rods respectively fastened to said mounting holes of said circuit board.

10. A card reader, comprising:
a housing, said housing comprising a USB standard casing and a holder block fastened to a rear side of said USB standard casing; said USB standard casing defining therein an accommodation chamber, said holder block defining an insertion hole for the insertion of an electronic card, said insertion hole being disposed in communication with said accommodation chamber perpendicularly;
an electric module mounted in said housing, said electric module comprising a circuit board mounted in said accommodation chamber of said USB standard casing, said circuit board comprising a first contact set configured subject to the USB specification and a second contact set disposed remote from said first contact set, and an electric connector perpendicularly mounted on said circuit board and electrically connected to said second contact set and kept in proximity to said insertion hole for the contact of an electronic card electrically; and
an expansion device, said expansion device comprising an electrically insulative rack fastened to a bottom wall of said circuit board of said electric module and defining with a bottom wall of said USB standard casing an insertion space for the insertion of an electronic card, and a plurality of conducting terminals mounted in said electrically insulative rack, each conducting terminal of said expansion device comprising a solder end electrically connected to said circuit board and a contact end obliquely protruding over a bottom wall of said electrically insulative rack and suspending in said insertion space for the contact of an electronic card.

11. The card reader as claimed in claim 10, wherein said insertion hole of said holder block is formed in a top side of said holder block for the loading of an electronic card into said holder block from the top side.

12. The card reader as claimed in claim 10, wherein said insertion hole of said holder block is formed in a bottom side of said holder block for the loading of an electronic card into said holder block from the bottom side.

13. The card reader as claimed in claim 10, wherein said holder block comprises two retaining protrusions disposed in said insertion hole at two opposite lateral sides for holding the inserted electronic card in contact with said electric connector electrically.

14. The card reader as claimed in claim 10, wherein said holder block comprises a front opening disposed in communication with said accommodation chamber of said USB standard casing, and two positioning grooves bilaterally disposed in said front opening; said USB standard casing comprises two rear friction arms respectively fastened to said positioning grooves of said holder block.

15. The card reader as claimed in claim 10, wherein said electric connector of said electric module is mounted on a top wall of said circuit board.

16. The card reader as claimed in claim 10, wherein said electric connector of said electric module is mounted on a bottom wall of said circuit board.

17. The card reader as claimed in claim 10, wherein said electric connector comprises an electrically insulative terminal holder and a plurality of conducting terminals mounted in said electrically insulative terminal holder, said electrically insulative terminal holder comprising a plurality of terminal slots and a plurality of locating grooves respectively disposed at one side relative to said terminal slots, each said conducting terminal of said electric connector comprising a solder end mounted in one said terminal slot and bonded to said second contact set of said circuit board, a springy contact end suspending in one said locating groove of said electrically insulative terminal holder, and an arched connection portion connected between said solder end and said springy contact end of the respective conducting terminal of said electric connector.

18. The card reader as claimed in claim 10, wherein said circuit board comprises a plurality of mounting holes; said electrically insulative terminal holder comprises a plurality of bottom mounting rods respectively fastened to said mounting holes of said circuit board.

19. The card reader as claimed in claim 10, wherein said holder block of said housing comprises a plurality of bottom sliding holes cut through a bottom wall thereof; said expansion device further comprises a card ejector for ejecting an electronic card out of said insertion space, said card ejector comprising a plurality of push blocks respectively slidably coupled to said bottom sliding holes of said holder block.

20. The card reader as claimed in claim 10, wherein said circuit board of said electronic module comprises a plurality of locating holes; said electrically insulative rack of said expansion device comprises a plurality of male locating portions respectively fastened to said locating holes of said circuit board.
